(19) United States
(12) Patent Application Publication
(10) Pub. No.: US 2015/0164730 A1
(43) Pub. Date: Jun. 18, 2015

(54) TILTING INVERSION EXERCISER HAVING ACTUATING HANDLE

(71) Applicant: Paul CHEN, Vancouver (CA)

(72) Inventor: Paul CHEN, Vancouver (CA)

(73) Assignee: Paul CHEN, Vancouver (CA)

(21) Appl. No.: 14/103,924

(22) Filed: Dec. 12, 2013

(51) Int. Cl. A61H 1/02

(52) U.S. Cl. CPC A61H 1/0218

(57) ABSTRACT

A tilting inversion exerciser includes a supporting stand for supporting a support member and having two upwardly extended columns, a supporting table includes a frame pivotally attached to the columns for pivoting relative to the supporting stand, and the support member is attached to the frame, two handle members are pivotally attached to the supporting stand, and two linking rods are pivotally coupled between the handle members and the supporting table for rotating the frame and the support member of the supporting table relative to the supporting stand. A telescopic device is coupled between the supporting table and the supporting stand for guiding and limiting the supporting table to rotate relative to the supporting stand.

### BACKGROUND OF THE INVENTION

1. Field of the Invention The present invention relates to a tilting inversion exerciser, and more particularly to a tilting inversion exerciser including a driving or actuating handle for selectively pivoting or rotating the supporting table relative to the supporting stand and for giving some security to the user, and for allowing the users, particularly the elders or disable persons to safely actuating or operating the tilting inversion exercisers.

2. Description of the Prior Art

Various kinds of typical inversion suspension exercisers, rotational exercisers, tilting inversion exercisers etc. have been developed and comprise a table rotatably or pivotally attached to an upper portion of a lower or base support or supporting stand with a pivot axle for supporting the user thereon, and rotatable relative to the base support for conducting various inversion or suspension exercises.

For example, U.S. Pat. No. 7,125,372 to Teeter et al., U.S. Pat. No. 7,507,192 to Teeter et al., U.S. Pat. No. 7,585,264 to Wang et al., U.S. Pat. No. 7,625,327 to Teeter et al., and U.S. Pat. No. 7,867,154 to Teeter et al. disclose several of the typical inversion suspension exercisers each comprising a table rotatably or pivotally attached to a base support or supporting stand for supporting the user thereon, and arranged for allowing the users to rotate the table relative to the base support, and to do various inversion or suspension exercises.

However, when the table of the typical inversion suspension exerciser is rotated relative to the base support or supporting stand to a tilted or inclined position, the users, particularly the elders or disable persons may feel unsafe and may be afraid that he may have a good chance to fall down to the ground, but the typical inversion suspension exercisers do not have any driving or actuating handle for selectively pivoting or rotating the supporting table relative to the supporting stand and for giving some security to the user, and for allowing the users, particularly the elders or disable persons to safely actuating or operating the tilting inversion suspension exerciser.

The present invention has arisen to mitigate and/or obviate the afore-described disadvantages of the conventional tilting inversion exercisers.

### SUMMARY OF THE INVENTION

The primary objective of the present invention is to provide a tilting inversion exerciser including a driving or actuating handle for selectively pivoting or rotating the supporting table relative to the supporting stand and for giving some security to the user, and for allowing the users, particularly the elders or young people or disable persons to safely actuating or operating the tilting inversion exercisers.

In accordance with one aspect of the invention, there is provided a tilting inversion exerciser comprising a supporting stand including a first column and a second column extended upwardly therefrom, the first and the second columns each including an upper portion, a supporting table including a frame having a first side element and a second side element pivotally attached to the upper portions of the first and the second columns respectively for allowing the frame of the supporting table to be pivoted and rotated relative to the supporting stand, and including a support member attached to the frame, two handle members pivotally attached to the supporting stand and to be rotated relative to the supporting stand, and two linking rods pivotally coupled between the handle members and the supporting table for rotating the frame and the support member of the supporting table relative to the supporting stand.

The handle members each include a lower portion pivotally attached to the first and the second column of the supporting stand with a pivot pin. The supporting table includes a foot retaining device attached to the support member.

The supporting stand includes a telescopic device coupled between the support member of the supporting table and the supporting stand for guiding and limiting the support member of the supporting table to rotate relative to the supporting stand.

The telescopic device includes a tube pivotally attached to the support member, and an extension slidably engaged in the tube and pivotally mounted to the supporting stand.

The supporting stand includes a safety locking mechanism coupled between the handle members and the supporting stand for selectively latching or locking the handle members to the supporting stand and for preventing the support member of the supporting table and the handle members from being rotated relative to the supporting stand.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a front perspective view of a tilting inversion exerciser in accordance with the present invention;

FIG. 2 is a rear perspective view of the tilting inversion exerciser;

FIG. 3 is a partial exploded view of the tilting inversion exerciser as seen from the rear portion of the tilting inversion exerciser;

FIG. 4 is a side plan schematic view of the tilting inversion exerciser; FIG. 5 is another side plan schematic view similar to FIG. 4, illustrating the operation of the tilting inversion exerciser; and

FIG. 6 is an enlarged partial side plan schematic view of the tilting inversion exerciser.

### DETAILED DESCRIPTION OF THE PREFERRED EMBODIMENT

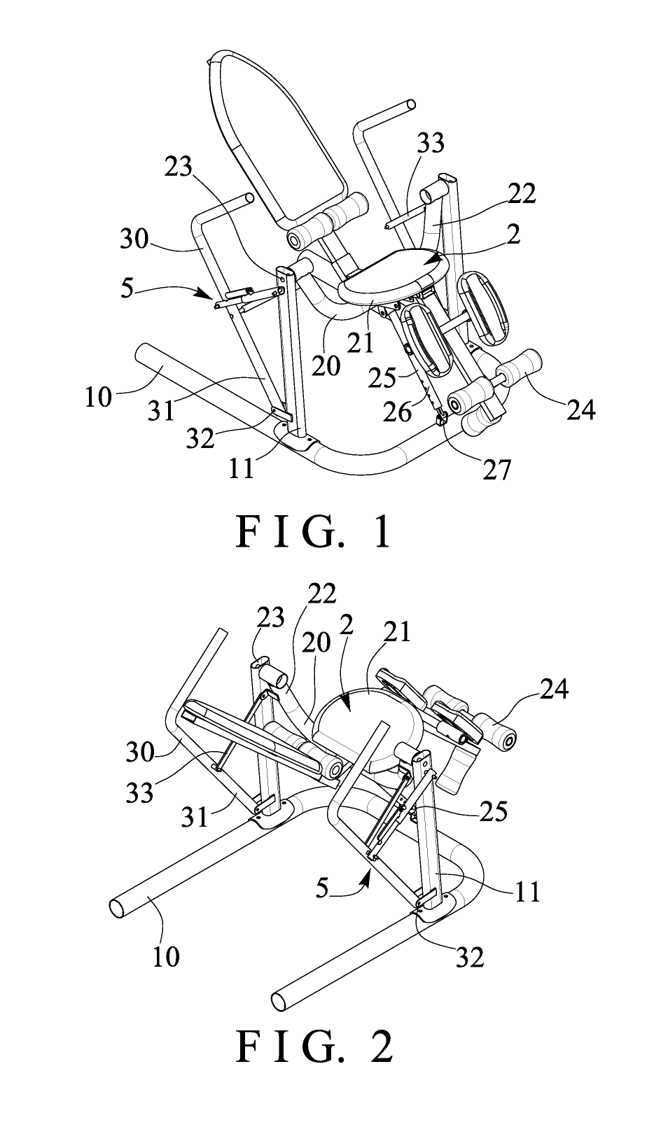

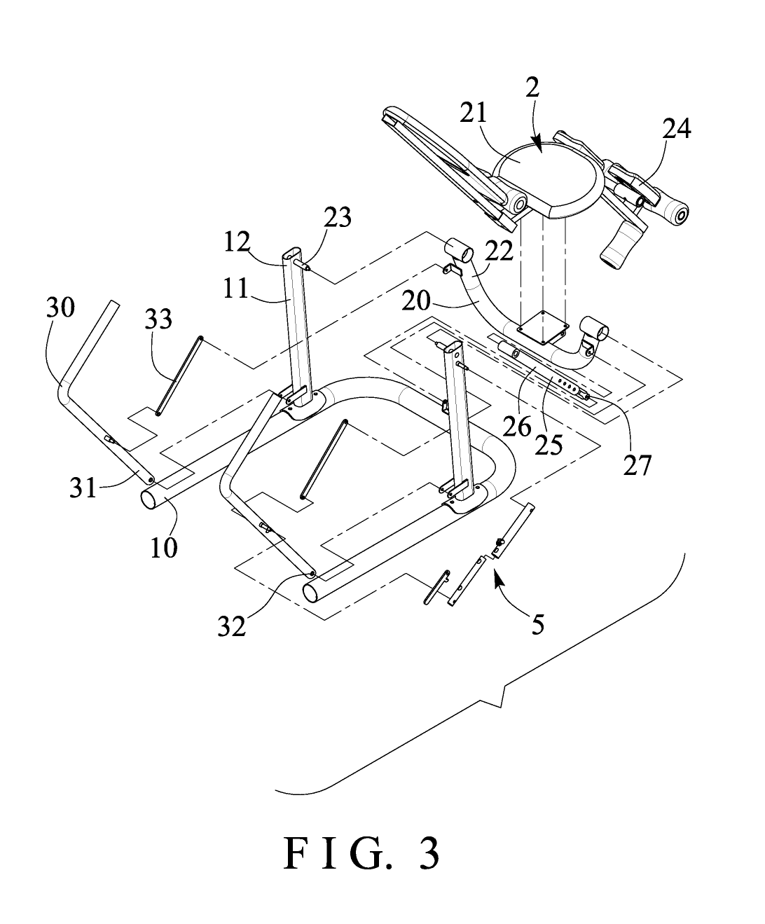

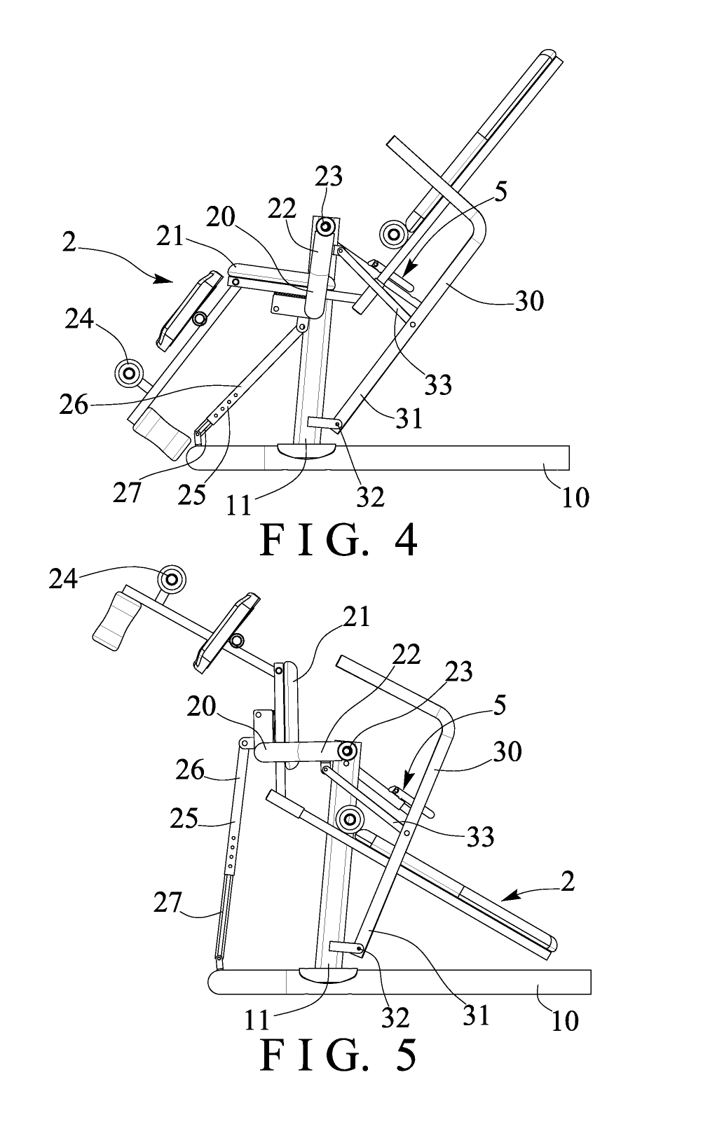

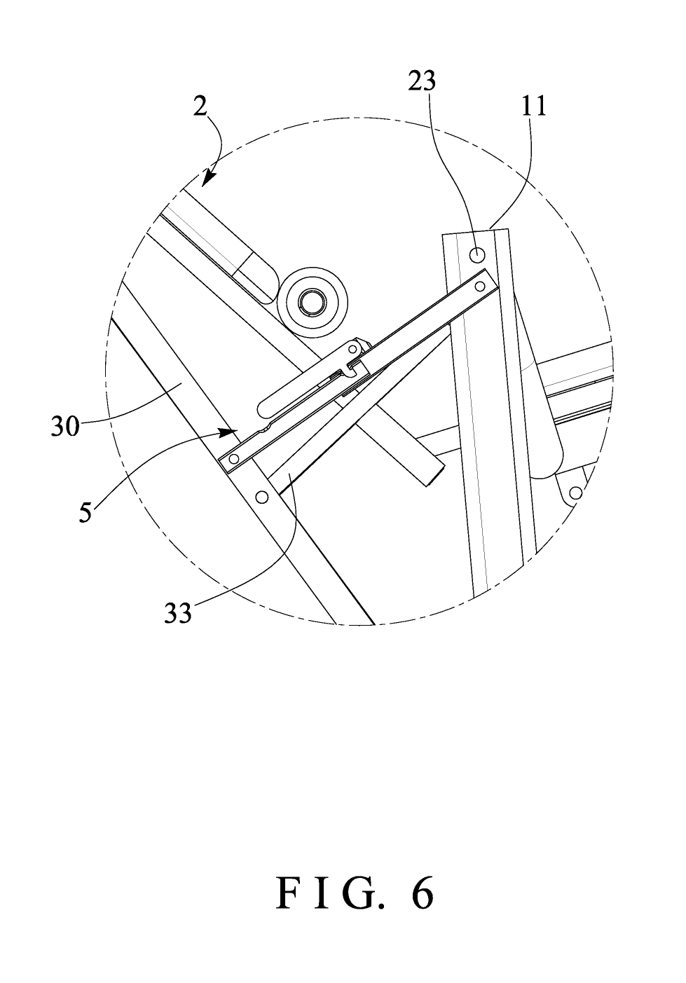

Referring to the drawings, and initially to FIGS. 1-4, a tilting inversion exerciser in accordance with the present invention comprises a lower supporting stand 10 for pivotally or rotatably supporting a base or seat or table 2 thereon, and for supporting a user on the supporting table 2, for example, the lower supporting stand 10 includes two rods or posts or columns 11 extended upwardly therefrom and preferably parallel to each other, and the columns 11 each include an upper portion 12 for pivotally or rotatably supporting or engaging with the supporting table 2. For example, the supporting table 2 includes a lower frame 20, such as a U-shaped frame 20 for attaching or mounting or securing or supporting a seat or table plate or seat or support member 21 thereon and for supporting the user on the support member 21.

For example, the frame 20 includes two end or side portions or segments or elements 22 each pivotally or rotatably attached or mounted or secured to the upper portion 12 of the respective column 11 with a pivot axle 23 for allowing the support member 21 and the frame 20 of the supporting table 2 to be pivoted or rotated relative to the supporting stand 10 to any suitable or selected or predetermined angular positions or locations (FIGS. 4, 5). The supporting table 2 includes a foot pedal or foot support or foot retaining device 24 attached or mounted or secured to the support member 21 for supporting the feet of the user, and a telescopic device 25 includes a tube 26 pivotally or rotatably attached or mounted or secured to the support member 21 and/or the frame 20 of the supporting table 2, and a rod or extension 27 slidably received or engaged in the tube 26 and pivotally or rotatably attached or mounted or secured to the supporting stand 10.

In operation, the tube 26 and the extension 27 of the telescopic device 25 are attached or mounted or secured or coupled between the support member 21 and/or the frame 20 of the supporting table 2 and the supporting stand 10 and may be slid and moved relative to each other for guiding and/or for limiting the support member 21 and/or the frame 20 of the supporting table 2 to pivot or rotate relative to the supporting stand 10, and/or the telescopic device 25 may be selected from an oil or hydraulic device or pneumatic mechanism for resisting or retarding the pivoting or rotating movement of the support member 21 and/or the frame 20 of the supporting table 2 relative to the supporting stand 10, and/or for preventing the support member 21 and/or the frame 20 of the supporting table 2 from being quickly pivoted or rotated relative to the supporting stand 10 and for giving some security to the user.

Two handle members 30 each include a lower or bottom portion 31 pivotally or rotatably attached or mounted or secured to the supporting stand 10, such as the column 11 of the supporting stand 10 with a pivot pin 32 for allowing the handle members 30 to be pivoted or rotated relative to the supporting stand 10, and two linking rods 33 are pivotally or rotatably attached or mounted or secured or coupled between the handle members 30 and the frame 20 or the support member 21 of the supporting table 2 for allowing the frame 20 and/or the support member 21 of the supporting table 2 to be selectively pivoted or rotated relative to the supporting stand 10 with or by the handle members 30.

A safety locking mechanism 5 may further be provided and attached or mounted or secured or coupled between the handle members 30 and the columns 11 of the supporting stand 10 for selectively latching or locking the handle members 30 to the columns 11 of the supporting stand 10 and for preventing the support member 21 and/or the frame 20 of the supporting table 2 and the handle members 30 from being pivoted or rotated relative to the supporting stand 10 and for giving some security to the user. In operation, as shown in FIGS. 4 and 5, when the user may hold or grip or grasp the handle members 30 and may pull or actuate or operate or move or pivot or rotate the support member 21 and/or the frame 20 of the supporting table 2 relative to the supporting stand 10 with or by the handle members 30 in order to selectively actuate or operate or train or exercise the hands and/or the upper muscle groups of the user. The safety locking mechanism 5 may also be selected from a telescopic device for guiding and/or for limiting the handle members 30 to pivot or rotate relative to the supporting stand 10, or may be selected from an oil or hydraulic device or pneumatic mechanism for resisting or retarding the pivoting or rotating movement of the handle members 30 relative to the supporting stand 10, and/or for preventing the handle members 30 from being pivoted or rotated relative to the supporting stand 10 inadvertently and for giving some security to the user.

Accordingly, the tilting inversion exerciser in accordance with the present invention includes a driving or actuating handle for selectively pivoting or rotating the supporting table relative to the supporting stand and for giving some security to the user, and for allowing the users, particularly the elders or young people or disable persons to safely actuating or operating the tilting inversion exercisers.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tilting inversion exerciser comprising:
a supporting stand including a first column and a second column extended upwardly therefrom, said first and said second columns each including an upper portion,
a supporting table including a frame having a first side element and a second side element pivotally attached to said upper portions of said first and said second columns respectively for allowing said frame of said supporting table to be pivoted and rotated relative to said supporting stand, and including a support member attached to said frame,
two handle members pivotally attached to said supporting stand and to be rotated relative to said supporting stand, and
two linking rods pivotally coupled between said handle members and said supporting table for rotating said frame and said support member of said supporting table relative to said supporting stand.

2. The tilting inversion exerciser as claimed in claim 1, wherein said handle members each include a lower portion pivotally attached to said first and said second column of said supporting stand with a pivot pin.

3. The tilting inversion exerciser as claimed in claim 1, wherein said supporting stand includes a telescopic device coupled between said support member of said supporting table and said supporting stand for guiding and limiting said support member of said supporting table to rotate relative to said supporting stand.

4. The tilting inversion exerciser as claimed in claim 3, wherein said telescopic device includes a tube pivotally attached to said support member, and an extension slidably engaged in said tube and pivotally mounted to said supporting stand.

5. The tilting inversion exerciser as claimed in claim 1, wherein said supporting table includes a foot retaining device attached to said support member.

6. The tilting inversion exerciser as claimed in claim 1, wherein said supporting stand includes a safety locking mechanism coupled between said handle members and said supporting stand for selectively locking said handle members to said supporting stand and for preventing said support member of said supporting table and said handle members from being rotated relative to said supporting stand.
